(19) United States
(12) Patent Application Publication
(10) Pub. No.: US 2025/0322137 A1
(43) Pub. Date: Oct. 16, 2025

(54) Electromagnetic Noise Analysis Device and Electromagnetic Noise Analysis Method

(71) Applicant: Hitachi, Ltd., Chiyoda-ku, Tokyo (JP)

(72) Inventors: Kiyoto MATSUSHIMA, Tokyo (JP); Aya OHMAE, Tokyo (JP)

(21) Appl. No.: 18/866,102

(22) PCT Filed: Apr. 5, 2023
(86) PCT No.: PCT/JP2023/014092

§ 371 Date: Nov. 15, 2024

(30) Foreign Application Priority Data
Jun. 16, 2022 (JP) 2022-096932

(51) Int. Cl. G06F 30/394; G06F 119/02; G06F 119/10

(52) U.S. Cl. CPC G06F 30/394; G06F 2119/02; G06F 2119/10

(57) ABSTRACT

An object of the invention is to provide an electromagnetic noise analysis device capable of analyzing a propagation path in a short time even for electromagnetic noise in a high frequency band and securing a certain level of reliability of an analysis result. For this purpose, an electromagnetic noise analysis device according to the invention includes: a propagation characteristic estimation unit configured to statistically estimate an electromagnetic field characteristic in a housing based on information about a housing structure and an electric wire path to output propagation characteristic probability distribution data; a propagation amount calculation unit configured to statistically estimate a noise propagation amount propagated from a noise source to an affected device based on a frequency characteristic of noise generated by the noise source and the propagation characteristic probability distribution data to output data of noise probability distribution on the affected device; and a malfunction risk determination unit configured to determine a malfunction risk of the affected device based on the data of the noise probability distribution on the affected device.

### TECHNICAL FIELD

The present invention relates to an electromagnetic noise analysis device and an electromagnetic noise analysis method.

### BACKGROUND ART

In a system in which a plurality of electrical devices are combined, an electro-magnetic compatibility (EMC) design is performed since one electrical device may malfunction under an influence of electromagnetic noise generated from another electrical device. As one of items in the EMC design, it is necessary to design, for a wiring in a housing such as a vehicle body, a path in consideration of resistance to electromagnetic noise. For example, regarding an electromagnetic noise analysis technique, PTL 1 is known.

### CITATION LIST

### Patent Literature

PTL 1: JP2013-186683A

### SUMMARY OF INVENTION

### Technical Problem

In a related-art wiring path design, for example, as in PTL 1, a general electromagnetic field analysis, that is, an analysis is mainly performed in which a three-dimensional model of a housing constituting a vehicle body or the like is divided into meshes, and a current value propagated from a noise source is calculated for each of the meshes. However, when a frequency of a signal to be used is high (when a wavelength is short), an amount of the meshes needs to be increased, and thus an analysis time is lengthened. In particular, in recent years, the analysis time tends to be further longer since a frequency used is increased to a GHz region. In the general electromagnetic field analysis, reliability of an analysis result may decrease when a three-dimensional shape obtained by modeling the housing and an actual shape are deviated.

An object of the invention is to provide an electromagnetic noise analysis device capable of analyzing a propagation path in a short time even for electromagnetic noise in a high frequency band and securing a certain level of reliability of an analysis result.

### Solution to Problem

In order to solve the above problems, an electromagnetic noise analysis device according to the invention includes: a propagation characteristic estimation unit configured to statistically estimate an electromagnetic field characteristic in a housing based on information about a housing structure and an electric wire path to output propagation characteristic probability distribution data; a propagation amount calculation unit configured to statistically estimate a noise propagation amount propagated from a noise source to an affected device based on a frequency characteristic of noise generated by the noise source and the propagation characteristic probability distribution data to output data of noise probability distribution on the affected device; and a malfunction risk determination unit configured to determine a malfunction risk of the affected device based on the data of the noise probability distribution on the affected device.

### Advantageous Effects of Invention

According to the invention, it is possible to provide an electromagnetic noise analysis device capable of analyzing a propagation path in a short time even for electromagnetic noise in a high frequency band and securing a certain level of reliability of an analysis result.

Problems, configurations, and effects other than those described above will be clarified by the following description of embodiments.

### BRIEF DESCRIPTION OF DRAWINGS

FIG. 1 is a diagram showing an overall configuration of a computer system according to Embodiment 1.

FIG. 2 is a diagram showing an overall flow of electromagnetic noise analysis according to Embodiment 1.

FIG. 3 is a diagram showing a specific calculation flow in a broken-line-shown portion in FIG. 2.

FIG. 4 is a diagram showing an example of data of propagation characteristic probability distribution between a noise source and an affected device.

FIG. 5 is a graph when FIG. 4 is viewed from a z-axis direction.

FIG. 6 is a diagram showing an overall image of electromagnetic noise analysis according to Embodiment 2.

FIG. 7 is a flowchart showing processing performed by a malfunction risk determination unit according to Embodiment 2.

FIG. 8 is a diagram showing an example of a determination result from the malfunction risk determination unit.

FIG. 9 is a diagram showing an overall image of electromagnetic noise analysis according to Embodiment 3.

FIG. 10 is a diagram showing an overall image of electromagnetic noise analysis according to Embodiment 4.

### DESCRIPTION OF EMBODIMENTS

Hereinafter, an embodiment according to the invention will be described with reference to the drawings. The embodiment is an example for describing the invention, and is omitted and simplified as appropriate for clarity of description. The invention can be implemented in various other forms. Unless otherwise specified, each component may be single or plural.

In the embodiment, processing performed by executing a program may be described. Here, a computer executes the program by a processor (for example, a CPU or a GPU) to perform processing defined by the program while using a storage resource (for example, a memory), an interface device (for example, a communication port), or the like. Therefore, a subject of the processing performed by executing the program may be the processor. Similarly, the subject of the processing performed by executing the program may be a controller, an apparatus, a system, a computer, or a node including the processor. The subject of the processing performed by executing the program may be a calculation unit and may include a dedicated circuit that performs specific processing. Here, the dedicated circuit is, for example, a field programmable gate array (FPGA), an application specific integrated circuit (ASIC), and a complex programmable logic device (CPLD).

The program may be installed on the computer from a program source. The program source may be, for example, a program distribution server or a computer-readable storage medium. When the program source is the program distribution server, the program distribution server may include a processor and a storage resource for storing a program to be distributed, and the processor of the program distribution server may distribute the program to be distributed to another computer. In the embodiment, two or more programs may be implemented as one program, or one program may be implemented as two or more programs.

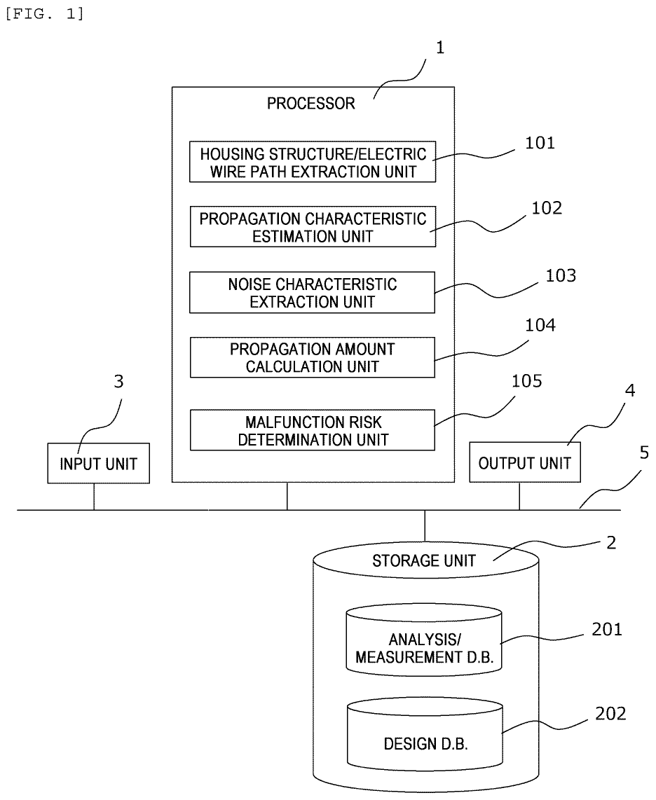

An electromagnetic noise analysis method and device according to an embodiment of the invention will be described below with reference to FIGS. 1 to 10. In the present embodiment, in particular, an example will be described in which an EMC risk of a harness (wiring) laid in a vehicle such as an electric automobile is evaluated and reflected in a design of a wiring path.

In an electric automobile, an inverter that converts a direct current output from a battery into an alternating current is used in order to drive tires by a motor. The inverter is connected to the battery and also connected to the motor using a wiring (motor cable). When the electric automobile accelerates or decelerates, a control signal is transmitted from an engine control unit (ECU) to the inverter via a wiring (control cable), and torque control based on pulse modulation is performed according to the signal by the inverter. Noise occurs during the pulse modulation of the inverter, and when a part of the noise is leaked to the outside, the leaked noise may be carried on a wiring inside the vehicle as a noise signal. When the noise signal carried on the wiring overlaps with a signal for controlling electrical devices, for example, the ECU and an antenna of a global positioning system (GPS) in the vehicle, these devices may malfunction. Accordingly, it is necessary to design a wiring path in consideration of resistance to noise.

Therefore, in the present embodiment, by incorporating a statistical evaluation into electromagnetic field analysis, it is possible to implement a wiring path design in which an analysis time can be shortened and a certain level of reliability of an analysis result can be ensured. Specifically, an influence of characteristic fluctuation caused by a shape of a housing or the like is reduced by applying a random coupling model (RCM) theory.

The RCM theory is a theory in which when a high-frequency electromagnetic wave propagating in a housing having a complicated shape has a wavelength that is sufficiently short (for example, less than one-tenth) with respect to the housing, the electromagnetic wave is reflected multiple times and can be considered to be in a random state after a certain time has passed, and an electromagnetic field can be modeled as a statistical intensity distribution. The RCM theory can also be applied to a vehicle body since the vehicle body has a shape that is not simple and is sufficiently large with respect with a wavelength of electromagnetic noise.

### Embodiment 1

An electromagnetic noise analysis method according to Embodiment 1 is implemented by a computer system. FIG. 1 is a diagram showing an overall configuration of the computer system according to Embodiment 1. As shown in FIG. 1, the computer system includes a processor 1, a storage unit 2, an input unit 3, an output unit 4, and a connection line 5 connecting these components. As described above, the processor 1 is, for example, a CPU. The storage unit 2 is a memory, a hard disk drive (HDD), or the like. The input unit 3 is a keyboard, a mouse, a touch panel, or the like. The output unit 4 is, for example, a display. The connection line 5 is a wiring on a circuit board, a connection cord, a network, or the like. These components do not need to be located at the same location, and may be located in remote locations and connected via a network or the like.

The processor 1 executes each of functions by reading and executing a program stored in the storage unit 2 or the like. In FIG. 1, the functions executed by the processor 1 are conceptually shown as a housing structure/electric wire path extraction unit 101, a propagation characteristic estimation unit 102, a noise characteristic extraction unit 103, a propagation amount calculation unit 104, and a malfunction risk determination unit 105. The details of each unit will be described later.

The storage unit 2 includes an analysis/measurement database 201 and a design database 202. The analysis/measurement database 201 stores affected device data (D16) and noise source data (D13). As an affected device, the ECU, various antennas, and the like are assumed. As a noise source, the inverter and various sensors are assumed. The affected device data (D16) corresponds to, for example, data related to vulnerability obtained through a test for a device and data related to an importance of a device. The data related to the vulnerability is data related to how much intensity of noise at a specified frequency will cause a malfunction in the affected device, and includes a reception sensitivity frequency characteristic and a plurality of thresholds (a voltage threshold and a probability threshold to be described later). The data related to the importance of the device is data indicating an influence degree of a risk for each device in the housing, and in a case of a vehicle, for example, an importance of a device that controls an operation of the vehicle is set to be higher than an importance of a device related to a car audio. The noise source data (D13) is data related to noise generated by the noise source, and is acquired in advance by analysis or actual measurement. The noise included in the acquired data may be radiated noise or conducted noise.

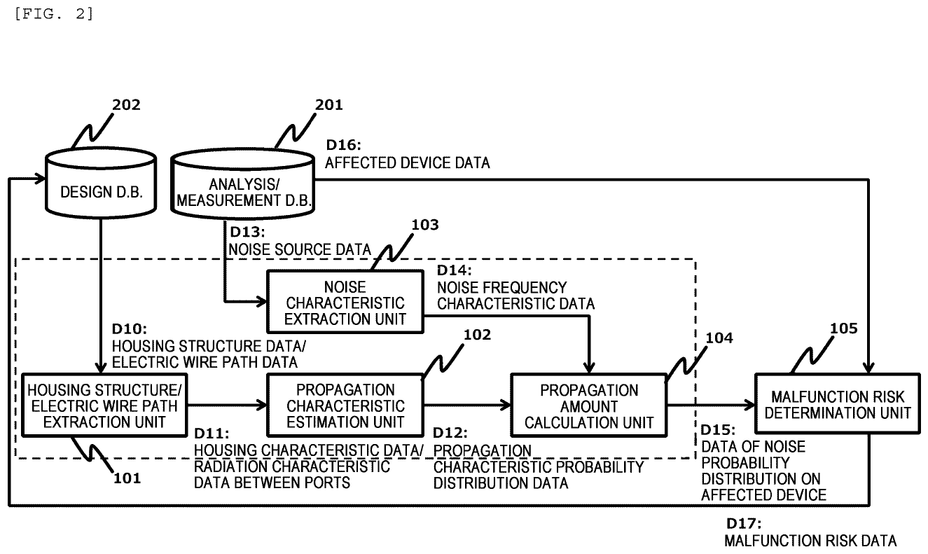

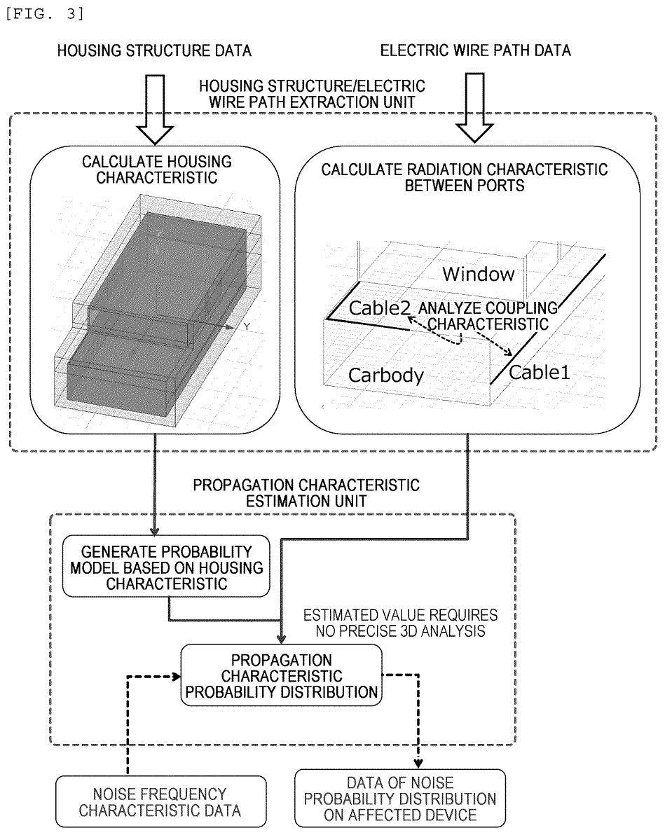

Next, a flow of electromagnetic noise analysis according to the present embodiment will be described with reference to FIGS. 2 to 5. FIG. 2 is a diagram showing an overall flow of the electromagnetic noise analysis according to Embodiment 1. FIG. 3 is a diagram showing a specific calculation flow in a broken-line-shown portion in FIG. 2.

First, as preprocessing for processing in which the RCM theory is applied, which is performed by the propagation characteristic estimation unit 102, the housing structure/electric wire path extraction unit 101 acquires housing structure data and electric wire path data (D10) from the design database 202, and calculates a housing characteristic and a propagation characteristic (a coupling characteristic of an electric wire path) between ports. The housing characteristic is a characteristic that is obtained by the housing structure/electric wire path extraction unit 101 performing calculation based on the housing structure data acquired from the design database 202, and includes a volume and a Q value of the housing (vehicle body). Meanwhile, the propagation characteristic between the ports is a characteristic obtained by the housing structure/electric wire path extraction unit 101 individually calculating a relation between a certain port and another port (for example, an influence of a noise source, which is the certain port, on an affected device which is another port) based on the electric wire path data acquired from the design database 202. In the calculation, it is sufficient to model only a neighboring region that influences a radiation characteristic of each port, and thus a calculation cost can be reduced.

Next, the propagation characteristic estimation unit 102 executes processing in which the RCM theory is applied. That is, as shown in FIG. 3, the propagation characteristic estimation unit 102 generates a plurality of distribution patterns by random matrix calculation based on the housing characteristic calculated by the housing structure/electric wire path extraction unit 101, and expresses a state of an electromagnetic field in the housing (vehicle body) as a characteristic model of probability distribution centered on a mode. Further, the propagation characteristic estimation unit 102 estimates propagation characteristic probability distribution using the characteristic model (distant characteristic model) that is based on the housing characteristic and a characteristic model (neighborhood characteristic model) that is based on the radiation characteristic of each port and the propagation characteristic between the ports calculated by the housing structure/electric wire path extraction unit 101. The propagation characteristic probability distribution can be obtained as an estimated value without performing precise 3D analysis, which leads to a reduction in analysis time.

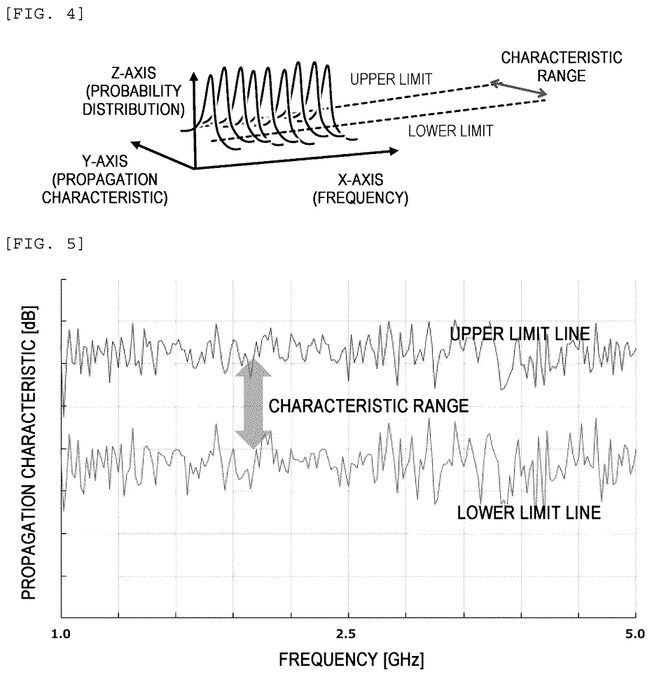

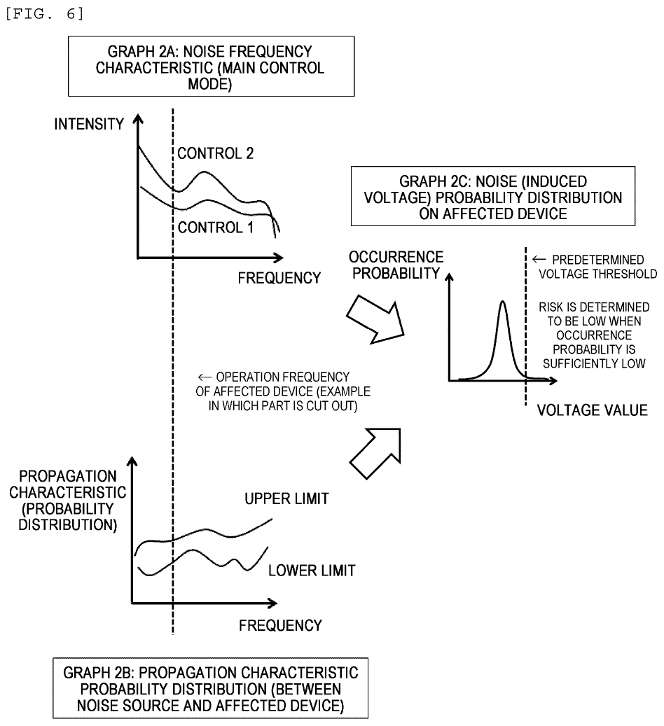

FIG. 4 is a diagram showing an example of data of the propagation characteristic probability distribution between the noise source and the affected device. An x-axis represents a frequency, a y-axis represents a propagation characteristic, and a z-axis represents a probability distribution. FIG. 5 is a graph when FIG. 4 is viewed from a z-axis direction, an x-axis represents the frequency, and a y-axis represents the propagation characteristic.

According to FIGS. 4 and 5, it is understood that the propagation characteristic which is easiness of transmission of noise from the noise source to the affected device differs among frequencies, and the probability distribution also differs. In FIG. 4, a characteristic range generated at a certain probability or more cannot be ignored, and thus an upper limit line and a lower limit line as shown in FIG. 5 are drawn when an upper limit and a lower limit of the propagation characteristic are defined in a form corresponding to the characteristic range. Further, in FIG. 4, when peaks of the probability distributions are connected for the respective frequencies, a line of modes can be drawn in FIG. 5.

Meanwhile, the noise characteristic extraction unit 103 acquires the noise source data (D13) from the analysis/measurement database 201 and extracts a frequency characteristic of noise generated by the noise source.

The propagation amount calculation unit 104 statistically estimates a noise propagation amount propagated from the noise source to the affected device based on propagation characteristic probability distribution data (D12) output by the propagation characteristic estimation unit 102 and noise frequency characteristic data (D14) output by the noise characteristic extraction unit 103.

The malfunction risk determination unit 105 determines a risk of malfunction of the affected device based on data of the noise probability distribution on the affected device (D15) output by the propagation amount calculation unit 104 and the affected device data (D16) output by the analysis/measurement database 201. For example, the malfunction risk determination unit 105 calculates a malfunction occurrence probability of the affected device based on a result of a calculation such as a multiplication using the reception sensitivity frequency characteristic (information indicating how much noise applied to the affected device and in which frequency band will cause malfunction) included in the affected device data (D16) and the data of the noise probability distribution on the affected device (D15). Further, the malfunction risk determination unit 105 may compare the malfunction occurrence probability with a predetermined threshold included in the affected device data (D16), and may determine that the risk is high when the probability is equal to or greater than the threshold and is low when the probability is less than the threshold.

A determination result from the malfunction risk determination unit 105 is output to the design database 202 as malfunction risk data (D17). The malfunction risk data (D17) is stored in the design database 202, is fed back to a safety integrity level (SIL) design as a failure rate as necessary, and is used to update design data. The malfunction risk data (D17) is displayed via the output unit 4 as, for example, “when performing XX operation, an error occurs with a XX probability”. As described above, the risk is quantitatively expressed as the malfunction occurrence probability of the affected device, which is useful in an EMC design.

### Embodiment 2

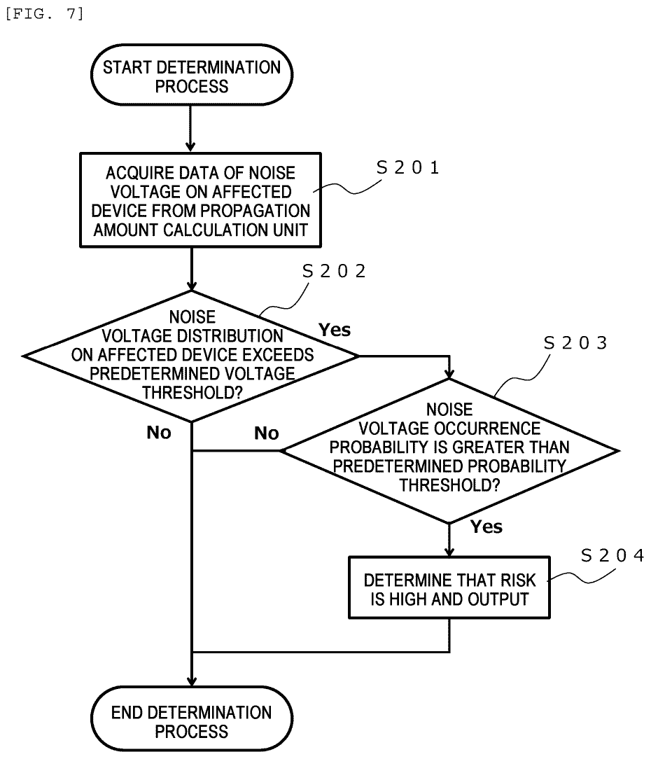

An electromagnetic noise analysis method according to Embodiment 2 will be described with reference to FIGS. 6 to 8. FIG. 6 is a diagram showing an overall image of electromagnetic noise analysis according to Embodiment 2. The present embodiment is different from Embodiment 1 in the following two points.

A first difference is that the noise characteristic extraction unit 103 in the present embodiment extracts a plurality of noise frequency characteristics respectively for operation states of the noise source. For example, when the noise source is an inverter of an electric automobile, the noise characteristic extraction unit 103 distinguishes and extracts a frequency characteristic of noise generated by switching the inverter during an acceleration operation and a frequency characteristic of noise generated by switching the inverter during a regeneration (deceleration) operation. A graph 2A in FIG. 6 shows the frequency characteristics of the noise in an acceleration mode that is set to a control 1 and in a regeneration mode that is set to a control 2. Thus, by using different noise frequency characteristic data for each main control mode, accuracy of the noise probability distribution on the affected device obtained by the propagation amount calculation unit 104 is improved, and as a result, a determination accuracy of the malfunction risk determination unit 105 is also improved. Further, even during the same acceleration operation, a switching interval of the inverter in a low speed region is different from a switching interval of the inverter in a high speed region, and thus it is desirable to use different noise frequency characteristic data for each speed range.

A second difference is that the malfunction risk determination unit 105 according to the present embodiment does not calculate the malfunction occurrence probability itself, and determines a magnitude of risk such as whether excessively large noise (induced voltage) occurs and what degree such an occurrence probability is by comparison with a voltage threshold and a probability threshold.

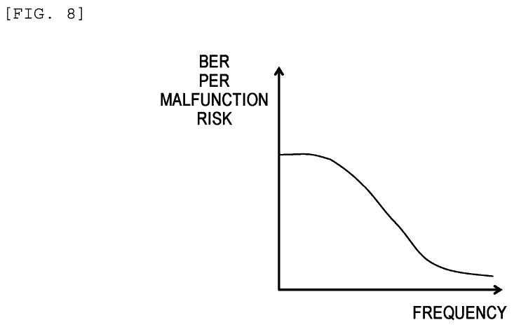

FIG. 7 is a flowchart showing processing performed by the malfunction risk determination unit according to Embodiment 2. As shown in FIG. 7, the malfunction risk determination unit 105 according to the present embodiment first obtains probability distribution of the induced voltage on the affected device (graph 2C in FIG. 6) as the data of the noise probability distribution on the affected device (D15) from the propagation amount calculation unit 104 (step S201). Next, the malfunction risk determination unit 105 determines whether the probability distribution of the induced voltage on the affected device exceeds a predetermined voltage threshold (step S202).

In step S202, when the probability distribution of the induced voltage exceeds the voltage threshold, the malfunction risk determination unit 105 determines whether a probability at which noise of the induced voltage occurs is greater than a predetermined probability threshold (step S203). When the noise occurrence probability is greater than the probability threshold, the malfunction risk determination unit 105 determines that a risk is high, outputs the determination result to the design database 202 (step S204), and ends the determination process.

On the other hand, when the probability distribution of the induced voltage is equal to or less than the voltage threshold in step S202, or when the noise occurrence probability is equal to or less than the probability threshold in step S203, the malfunction risk determination unit 105 ends the determination process without outputting the determination result to the design database 202. As described above, even when there is a possibility that noise having a high intensity occurs (exceeds the voltage threshold), if the occurrence probability is sufficiently low (does not exceed the probability threshold), the malfunction risk determination unit 105 in the present embodiment determines that the risk of malfunction of the affected device is low. That is, in the present embodiment, the risk is determined in consideration of not only an intensity of the noise but also the noise occurrence probability, and thus the determination can be performed with high accuracy and excessive EMC design can be avoided.

A voltage threshold related to a magnitude of a noise voltage and a probability threshold related to a noise occurrence probability are thresholds determined according to characteristics of the affected device, and are included in the affected device data (D16) output from the analysis/measurement database 201. It is desirable that the probability threshold corresponds to a reference value of a failure rate defined by the SIL.

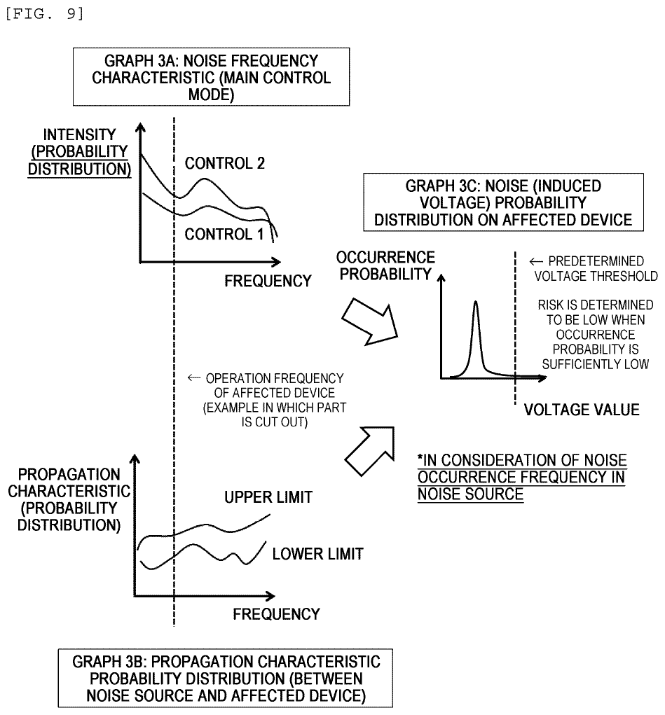

FIG. 8 is a diagram showing an example of the determination result from the malfunction risk determination unit. The malfunction risk determination unit 105 quantifies (visualizes) a malfunction risk that is the determination result as shown in FIG. 8, and outputs the quantified result to the design database 202.

### Embodiment 3

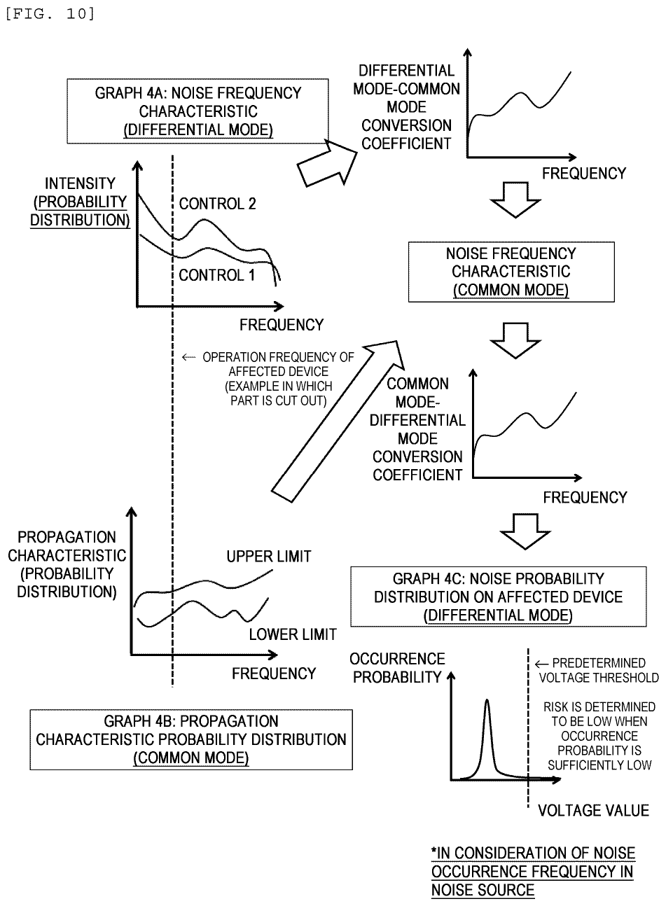

An electromagnetic noise analysis method according to Embodiment 3 will be described with reference to FIG. 9. FIG. 9 is a diagram showing an overall image of electromagnetic noise analysis according to Embodiment 3.

The present embodiment is different from Embodiment 2 in that the noise characteristic extraction unit 103 extracts not only the frequency characteristic of the noise but also the noise occurrence probability, and the propagation amount calculation unit 104 estimates the noise propagation amount using not only the frequency characteristic of the noise but also the noise occurrence probability. In consideration of the noise occurrence probability in the noise source as in the present embodiment, the accuracy of the noise probability distribution on the affected device obtained by the propagation amount calculation unit 104 is improved, and as a result, the determination accuracy of the malfunction risk determination unit 105 is also improved.

A graph 3A in FIG. 9 is a two-dimensional graph showing only a frequency (x-axis) and a noise intensity (y-axis), but a probability distribution (z-axis) is actually included as data having a width. In place of the noise occurrence probability, a frequency at which a control mode (such as the acceleration mode or the regeneration mode) is executed may be used.

### Embodiment 4

An electromagnetic noise analysis method according to Embodiment 4 will be described with reference to FIG. 10. FIG. 10 is a diagram showing an overall image of electromagnetic noise analysis according to Embodiment 4.

In the present embodiment, during the electromagnetic noise analysis, conducted noise generated due to left-right asymmetry of a connector shape or a structure is appropriately converted to be in a differential mode or a common mode.

As a premise, when the propagation characteristic estimation unit 102 performs processing in which the RCM theory is applied, target noise is limited to the common mode noise, and thus the propagation characteristic probability distribution data (D12) output by the propagation characteristic estimation unit 102 is also common-mode noise as shown in a graph 4B in FIG. 10. Therefore, when the frequency characteristic of the noise included in the noise source data (D13) is in the differential mode as shown in the graph 4A in FIG. 10, the noise characteristic extraction unit 103 converts the frequency characteristic of the noise into that in the common mode and outputs the converted frequency characteristic to the propagation amount calculation unit 104. Thus, the propagation amount calculation unit 104 can calculate the propagation amount based on the propagation characteristic probability distribution data (D12) of the common-mode noise and the noise frequency characteristic data (D14) converted to be in the common mode.

However, in order to determine the risk of the malfunction of the affected device by the malfunction risk determination unit 105, it is necessary to convert the noise propagation amount into that in the differential mode and evaluate the converted noise propagation amount. Therefore, the propagation amount calculation unit 104 according to the present embodiment converts the calculated propagation amount from the common mode to the differential mode, and outputs the converted data to the malfunction risk determination unit 105 as the data of the noise probability distribution on the affected device (D15).

The above embodiments have been described in detail to facilitate understanding of the invention, and the invention is not necessarily limited to those including all the configurations described above. A part of a configuration of a certain embodiment can be replaced with a configuration of another embodiment, and the configuration of another embodiment can be added to the configuration of a certain embodiment. Further, a part of a configuration in each embodiment may also be added to, deleted from, or replaced with another configuration.

For example, in the above embodiments, the housing structure/electric wire path extraction unit 101 extracts housing characteristic data and radiation characteristic data between the ports (D11), and the noise characteristic extraction unit 103 extracts the noise frequency characteristic data (D14), but when the D11 and the D14 are stored in advance in the design database 202 and the analysis/measurement database 201, the housing structure/electric wire path extraction unit 101 and the noise characteristic extraction unit 103 can be omitted. In the above embodiments, the noise source data (D13) and the affected device data (D16) are stored in the analysis/measurement database 201, but the data may be stored in different databases.

### Reference Signs List

1: processor
2: storage unit
3: input unit
4: output unit
5: connection line
101: housing structure/electric wire path extraction unit
102: propagation characteristic estimation unit
103: noise characteristic extraction unit
104: propagation amount calculation unit
105: malfunction risk determination unit
201: analysis/measurement database
202: design database

1. An electromagnetic noise analysis device comprising:
a propagation characteristic estimation unit configured statistically estimate to an electromagnetic field characteristic in a housing based on information about a housing structure and an electric wire path to output propagation characteristic probability distribution data;
a propagation amount calculation unit configured to statistically estimate a noise propagation amount propagated from a noise source to an affected device based on a frequency characteristic of noise generated by the noise source and the propagation characteristic probability distribution data to output data of noise probability distribution on the affected device; and
a malfunction risk determination unit configured to determine a malfunction risk of the affected device based on the data of the noise probability distribution on the affected device.

2. The electromagnetic noise analysis device according to claim 1, wherein
the propagation amount calculation unit estimates the noise propagation amount using a plurality of frequency characteristics of operation states of the noise source.

3. The electromagnetic noise analysis device according to claim 1, wherein
the propagation amount calculation unit estimates the noise propagation amount using not only the frequency characteristic of the noise but also a noise occurrence probability.

4. The electromagnetic noise analysis device according to claim 1, wherein
the malfunction risk determination unit determines the malfunction risk of the affected device also using data related to vulnerability of the affected device.

5. The electromagnetic noise analysis device according to claim 4, wherein
the malfunction risk determination unit outputs a malfunction occurrence probability of the affected device based on a result of a calculation using the data related to the vulnerability of the affected device and the data of the noise probability distribution on the affected device.

6. The electromagnetic noise analysis device according to claim 4, wherein
the data related to the vulnerability of the affected device includes a voltage threshold related to a magnitude of a noise voltage and a probability threshold related to a noise occurrence probability, and
the malfunction risk determination unit compares the data of the noise probability distribution on the affected device with the voltage threshold and the probability threshold to output a magnitude of the risk.

7. The electromagnetic noise analysis device according to claim 1, further comprising:
a noise characteristic extraction unit configured to convert the frequency characteristic of the noise from a differential mode to a common mode and output the converted frequency characteristic to the propagation amount calculation unit.

8. The electromagnetic noise analysis device according to claim 7, wherein
the propagation amount calculation unit converts the noise propagation amount from a common mode to a differential mode and outputs, to the malfunction risk determination unit, the converted noise propagation amount as the data of the noise probability distribution on the affected device.

9. An electromagnetic noise analysis method comprising:
a step of a propagation characteristic estimation unit statistically estimating an electromagnetic field characteristic in a housing based on information about a housing structure and an electric wire path to output propagation characteristic probability distribution data;
a step of a propagation amount calculation unit statistically estimating a noise propagation amount propagated from a noise source to an affected device based on a frequency characteristic of noise generated by the noise source and the propagation characteristic probability distribution data to output data of noise probability distribution on the affected device; and
a step of a malfunction risk determination unit determining a malfunction risk of the affected device based on the data of the noise probability distribution on the affected device.

10. The electromagnetic noise analysis method according to claim 9, wherein
the propagation amount calculation unit estimates the noise propagation amount using a plurality of frequency characteristics of operation states of the noise source.

11. The electromagnetic noise analysis method according to claim 9, wherein
the propagation amount calculation unit estimates the noise propagation amount using not only the frequency characteristic of the noise but also a noise occurrence probability.

12. The electromagnetic noise analysis method according to claim 9, wherein
the malfunction risk determination unit determines the malfunction risk of the affected device also using data related to vulnerability of the affected device.

13. The electromagnetic noise analysis method according to claim 9, further comprising:
a step of a noise characteristic extraction unit converting the frequency characteristic of the noise from a differential mode to a common mode.

14. The electromagnetic noise analysis method according to claim 13, wherein
the propagation amount calculation unit converts the data of the noise probability distribution on the affected device from a common mode to a differential mode and outputs the converted data.
